(19) United States
(12) Patent Application Publication
(10) Pub. No.: US 2013/0191779 A1
(43) Pub. Date: Jul. 25, 2013

(54) DISPLAY OF USER INTERFACE ELEMENTS BASED ON TOUCH OR HARDWARE INPUT

(71) Applicants: Samuel Chow Radakovitz, Puyallup, WA (US); Clinton Dee Covington, Redmond, WA (US)

(72) Inventors: Samuel Chow Radakovitz, Puyallup, WA (US); Clinton Dee Covington, Redmond, WA (US)

(73) Assignee: MICROSOFT CORPORATION, Redmond, WA (US)

(21) Appl. No.: 13/355,227

(22) Filed: Jan. 20, 2012

(51) Int. Cl. G06F 3/048; G06F 3/041

(52) U.S. Cl. 715/800; 715/764; 715/810; 715/788

(57) ABSTRACT

User interface elements are configured for touch input and hardware based input. When using touch input, the user interface (UI) elements are optimized for touch input. For example, UI elements may be displayed: using formatting configured for touch input (e.g. changing a size, spacing); using a layout configured for touch input; displaying more/fewer options; changing/removing hover actions, and the like. When using hardware based input, the user interface elements are optimized for the hardware based input. For example, formatting configured for hardware based input may be used (e.g. hover based input may be used, text may be displayed smaller), more/fewer options displayed, and the like.

### BACKGROUND

Many computing devices (e.g. smart phones, tablets, laptops, desktops) allow the use touch input and hardware based input (e.g. mouse, pen, trackball). Using touch input with applications that are designed for hardware based input can be challenging. For example, some interactions associated with hardware based input may not function properly with touch input.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

User interface elements are configured for touch input and hardware based input. When using touch input, the user interface (UI) elements are optimized for touch input. For example, UI elements may be displayed: using formatting configured for touch input (e.g. changing a size, spacing); using a layout configured for touch input; displaying more/fewer options; changing/removing hover actions, and the like. When using hardware based input, the user interface elements are optimized for the hardware based input. For example, formatting configured for hardware based input may be used (e.g. hover based input may be used, text may be displayed smaller), more/fewer options displayed, and the like.

### BRIEF DESCRIPTION OF THE DRAWINGS

FIG. 1 illustrates an exemplary computing environment;

FIG. 2 illustrates an exemplary system for displaying user interface elements optimized for touch input and optimized for hardware based input;

FIG. 3 shows an illustrative processes for optimizing user interface elements when using touch input and when using hardware based input;

FIG. 4 illustrates a system architecture used in changing the display of user interface elements based on input;

FIG. 5 shows UI elements arranged for hardware based input and UI elements arranged for touch input;

FIG. 6 shows UI elements arranged for touch input;

FIG. 7 shows UI elements sized for hardware based input and UI elements sized for touch input; and

FIG. 8 illustrates an exemplary sizing table that may be used in determining a size of UI elements.

### DETAILED DESCRIPTION

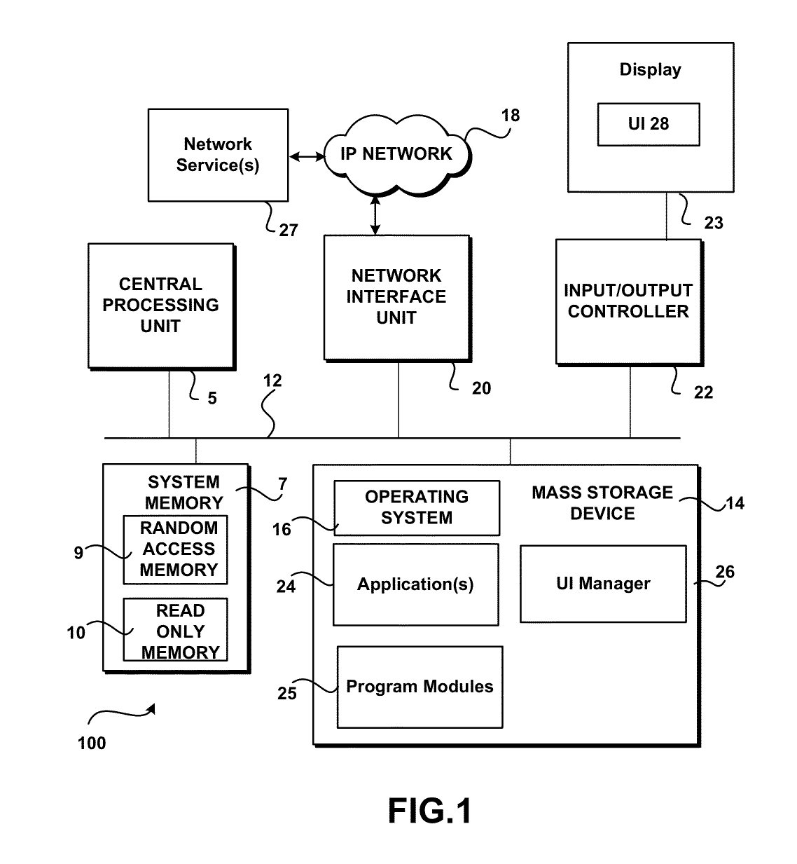

Referring now to the drawings, in which like numerals represent like elements, various embodiment will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer environment for a computer 100 utilized in the various embodiments will be described. The computer environment shown in FIG. 1 includes computing devices that each may be configured as a mobile computing device (e.g. phone, tablet, netbook, laptop), server, a desktop, or some other type of computing device and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, application(s) 24 (e.g. productivity application, Web Browser, and the like) and UI manager 26 which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

Computer 100 operates in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, a touch input device, or electronic stylus (not shown in FIG. 1). Similarly, an input/output controller 22 may provide input/output to a display screen 23, a printer, or other type of output device.

A touch input device may utilize any technology that allows single/multi-touch input to be recognized (touching/non-touching). For example, the technologies may include, but are not limited to: heat, finger pressure, high capture rate cameras, infrared light, optic capture, tuned electromagnetic induction, ultrasonic receivers, transducer microphones, laser rangefinders, shadow capture, and the like. According to an embodiment, the touch input device may be configured to detect near-touches (i.e. within some distance of the touch input device but not physically touching the touch input device). The touch input device may also act as a display. The input/output controller 22 may also provide output to one or more display screens 23, a printer, or other type of input/output device.

A camera and/or some other sensing device may be operative to record one or more users and capture motions and/or gestures made by users of a computing device. Sensing device may be further operative to capture spoken words, such as by a microphone and/or capture other inputs from a user such as by a keyboard and/or mouse (not pictured). The sensing device may comprise any motion detection device capable of detecting the movement of a user. For example, a camera may comprise a MICROSOFT KINECT® motion capture device comprising a plurality of cameras and a plurality of microphones.

Embodiments of the invention may be practiced via a system-on-a-chip (SOC) where each or many of the components/processes illustrated in the FIGURES may be integrated onto a single integrated circuit. Such a SOC device may include one or more processing units, graphics units, communications units, system virtualization units and various application functionality all of which are integrated (or “burned”) onto the chip substrate as a single integrated circuit. When operating via a SOC, all/some of the functionality, described herein, with respect to the Unified Communications via application-specific logic integrated with other components of the computing device/system 100 on the single integrated circuit (chip).

As mentioned briefly above, a number of program modules and data files may be stored in the mass storage device 14 and RAM 9 of the computer 100, including an operating system 16 suitable for controlling the operation of a computer, such as the WINDOWS 8®, WINDOWS PHONE 7®, WINDOWS 7®, or WINDOWS SERVER® operating system from MICROSOFT CORPORATION of Redmond, Wash. The mass storage device 14 and RAM 9 may also store one or more program modules. In particular, the mass storage device 14 and the RAM 9 may store one or more application programs, such as a spreadsheet application, word processing application and/or other applications. According to an embodiment, the MICROSOFT OFFICE suite of applications is included. The application(s) may be client based and/or web based. For example, a network service 27 may be used, such as: MICROSOFT WINDOWS LIVE, MICROSOFT OFFICE 365 or some other network based service.

UI manager 26 is configured to display user interface elements (e.g. UI 28) for an application based on a type of input currently being received (e.g. touch, hardware based input). For example, a user may sometimes interact with application 24 using touch input and in other situations use hardware based input to interact with the application. In response to receiving touch input, UI manager 26 displays a user interface element optimized for touch input. For example, touch UI elements may be displayed: using formatting configured for touch input (e.g. changing a size, spacing); using a layout configured for touch input; displaying more/fewer options; changing/removing hover actions, and the like. When using hardware based input, the UI manager displays UI elements for the application that are optimized for the hardware based input. For example, formatting configured for hardware based input may be used (e.g. hover based input may be used, text may be displayed smaller), more/fewer options displayed, and the like.

UI manager 26 may be located externally from an application, e.g. a productivity application or some other application, as shown or may be a part of an application. Further, all/some of the functionality provided by UI manager 26 may be located internally/externally from an application for which the user interface element is used for editing value(s) in place. More details regarding the UI manager are disclosed below.

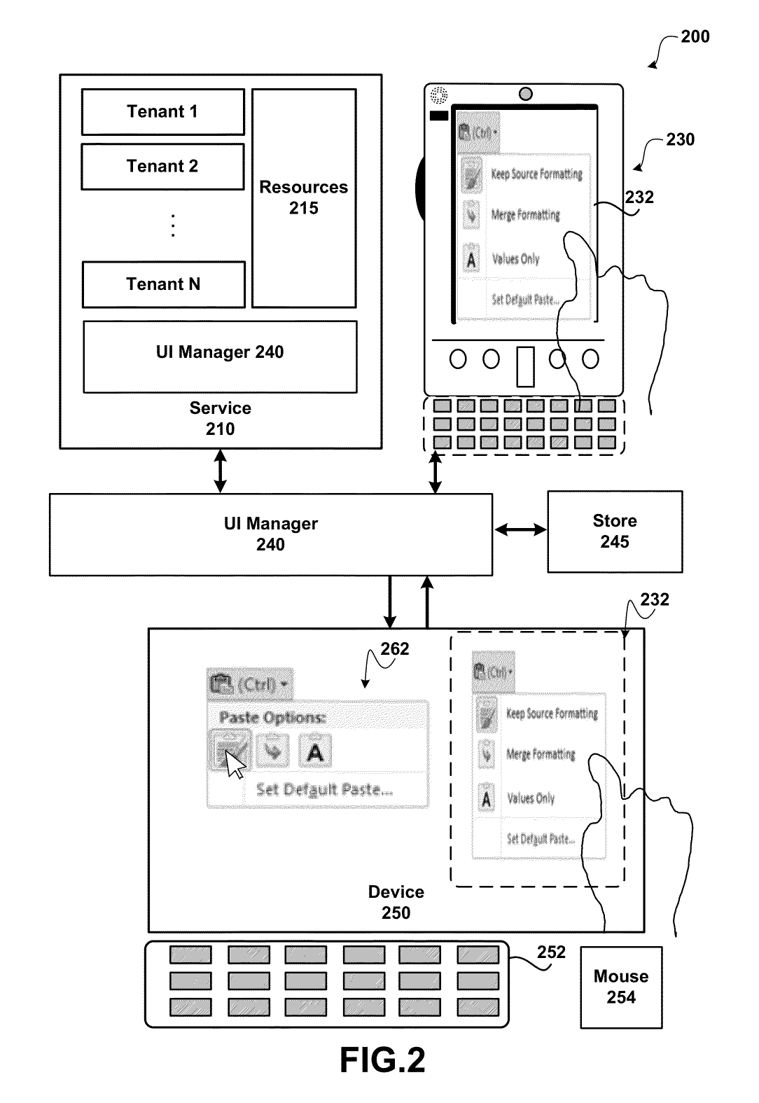

FIG. 2 illustrates an exemplary system for displaying user interface elements optimized for touch input and optimized for hardware based input. As illustrated, system 200 includes service 210, UI manager 240, store 245, device 250 (e.g. desktop computer, tablet) and smart phone 230.

As illustrated, service 210 is a cloud based and/or enterprise based service that may be configured to provide productivity services (e.g. MICROSOFT OFFICE 365 or some other cloud based/online service that is used to interact with items (e.g. spreadsheets, documents, charts, and the like). Functionality of one or more of the services/applications provided by service 210 may also be configured as a client based application. For example, a client device may include an application that performs operations in response to receiving touch input and/or hardware based input. Although system 200 shows a productivity service, other services/applications may be configured to select items. As illustrated, service 210 is a multi-tenant service that provides resources 215 and services to any number of tenants (e.g. Tenants 1-N). According to an embodiment, multi-tenant service 210 is a cloud based service that provides resources/services 215 to tenants subscribed to the service and maintains each tenant's data separately and protected from other tenant data.

System 200 as illustrated comprises a touch screen input device/smart phone 230 that detects when a touch input has been received (e.g. a finger touching or nearly touching the touch screen) and device 250 that may support touch input and/or hardware based input such as a mouse, keyboard, and the like. As illustrated, device 250 is a computing device that includes a touch screen that may be attached/detached to keyboard 252, mouse 254 and/or other hardware based input devices.

Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

Content (e.g. documents, files, UI definitions . . . ) may be stored on a device (e.g. smart phone 230, device 250 and/or at some other location (e.g. network store 245).

As illustrated, touch screen input device/smart phone 230 shows an exemplary display 232 of a menu including UI elements configured for touch input. Device 250 shows a display 262 of a menu including UI elements configured for hardware based input and display 232 of a menu including UI elements configured for touch input when a user is using touch input to interact with device 250. For purposes of illustration both display 232 and display 262 are shown at the same time. In operation, one of the menus is displayed based on the input being received.

UI manager 240 is configured to display differently configured user interface elements for an application based on whether touch input is being used or hardware based input is being used.

As illustrated on device 250, a user may switch between a docking mode and an undocked mode. For example, when in the docked mode, hardware based input may be used to interact with device 250 since keyboard 252 and mouse 254 are coupled to computing device 250. When in the undocked mode, touch input may be used to interact with device 250. A user may also switch between touch input and hardware based input when device 250 is in the docked mode.

The following is an example for illustrative purposes that is not intended to be limiting. Suppose that a user has a tablet computing device (e.g. device 250). While working from their desk, the user generally uses mouse 254 and keyboard 252 and leaves computing device 250 docked. The user may occasionally reach out to touch the monitor to scroll or adjust a displayed item, but the majority of the input while device 250 is docked is hardware based input using the mouse and keyboard. UI manager 240 is configured to display the UI elements for touch when the user is interacting using touch input and to display the UI elements for hardware based input when the user is interacting using hardware based input. The UI manager 240 may be part of the application the user is interacting with and/or separate from the application.

When the user undocks the computing device, UI manager may automatically switch the computing device to touch input mode since device 250 is no longer docked to the keyboard and mouse. In response to switching input to touch, UI manager 240 displays UI elements for the application that are adjusted for receiving the touch input. For example, menus (e.g. a ribbon), icons, and the like are sized larger as compared to when using hardware based input such that the UI elements are more touchable (e.g. can be selected more easily). UI elements may be displayed with more spacing, options in the menu may have their style changed, and some applications may adjust the layout of touch UI elements. In the current example, it can be seen that the menu items displayed when using hardware based input (display 262) are sized smaller and arranged horizontally as compared to touch based UI elements 232 that are sized larger and are spaced farther apart. Additional information may also be displayed next to the icon when in touch mode (e.g. 232) as compared to when receiving input using hardware based input. For example, when in hardware based input mode, hovering over an icon may display a “tooltip” that provides additional information about the UI element that is currently being hovered over. When in touch mode, the “tooltips” (e.g. “Keep Source Formatting”, “Merge Formatting”, and “Values Only”) are displayed along with the display of the icon.

After re-docking device 250, the user may manually turn off touch mode and/or touch mode may be automatically switched to hardware based input. For example, the UI elements may be sized smaller and spaced closer together. According to an embodiment, the UI elements change in response to a last input method by a user. A last input type flag may be used to store the last input mode (e.g. touched or clicked). While the application is running different pieces of UI adjust as they get triggered in based on the value of the last input type flag. The value of the last input type flag may also be queried.

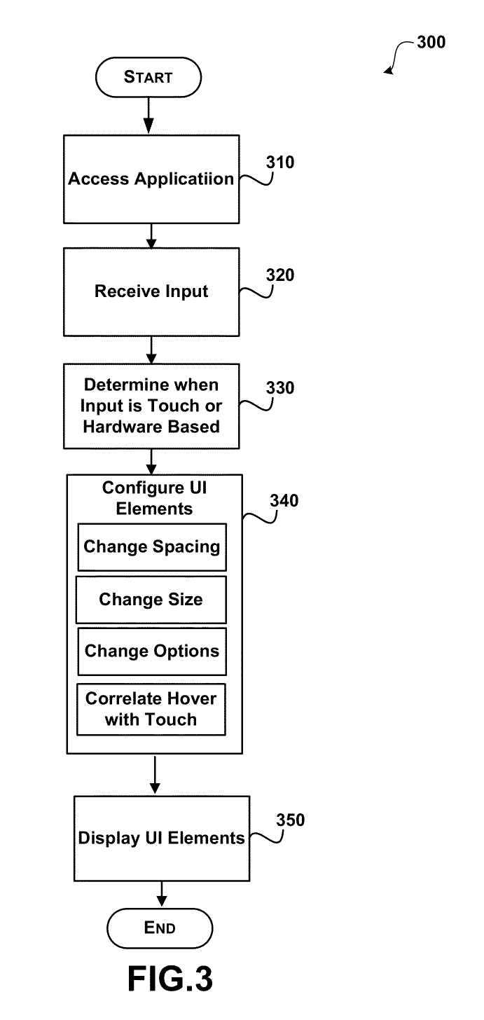

FIG. 3 shows an illustrative processes for optimizing user interface elements when using touch input and when using hardware based input. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof. While the operations are shown in a particular order, the ordering of the operations may change and be performed in other orderings.

After a start operation, process 300 moves to operation 310, where a user accesses an application. The application may be an operating environment, a client based application, a web based application, a hybrid application that uses both client functionality and/or network based functionality. The application may include any functionality that may be accessed using touch input and hardware based input.

Moving to operation 320, input is received. The input may be touch input or hardware based input. For example, the touch input may be a user's finger(s), a pen input device, and/or some other device that interacts directly with a display/screen of a computing device. According to an embodiment, the touch input is a touch input gesture. Hardware based input is input that is received from a device other than a device that directly interacts with the display such as, but not limited to: a keyboard, a mouse, a trackball, and the like.

Transitioning to operation 330, a determination is made as to whether the input is touch input or hardware based input. The determination may be made automatically/manually. For example, when the computing device is initially docked, the determination may be initially set to hardware based input. When a touch device is undocked, the determination may be initially set to touch input. A user may also manually set the mode to touch based and/or hardware based input. The input may also be set based on a last input method. For example, if a user touches the display, the mode may be touched to touch input until a hardware based input is received.

Flowing to operation 340, the UI elements for the application are configured based on the determined input method. The configuration of the UI elements may include adjusting one or more of: a spacing of elements, a size of the elements/text, options displayed, and associating hardware based input methods (e.g. hover) with touch based input displays.

Moving to operation 350, the UI elements that are configured for the input mode are displayed.

The process then flows to an end block and returns to processing other actions.

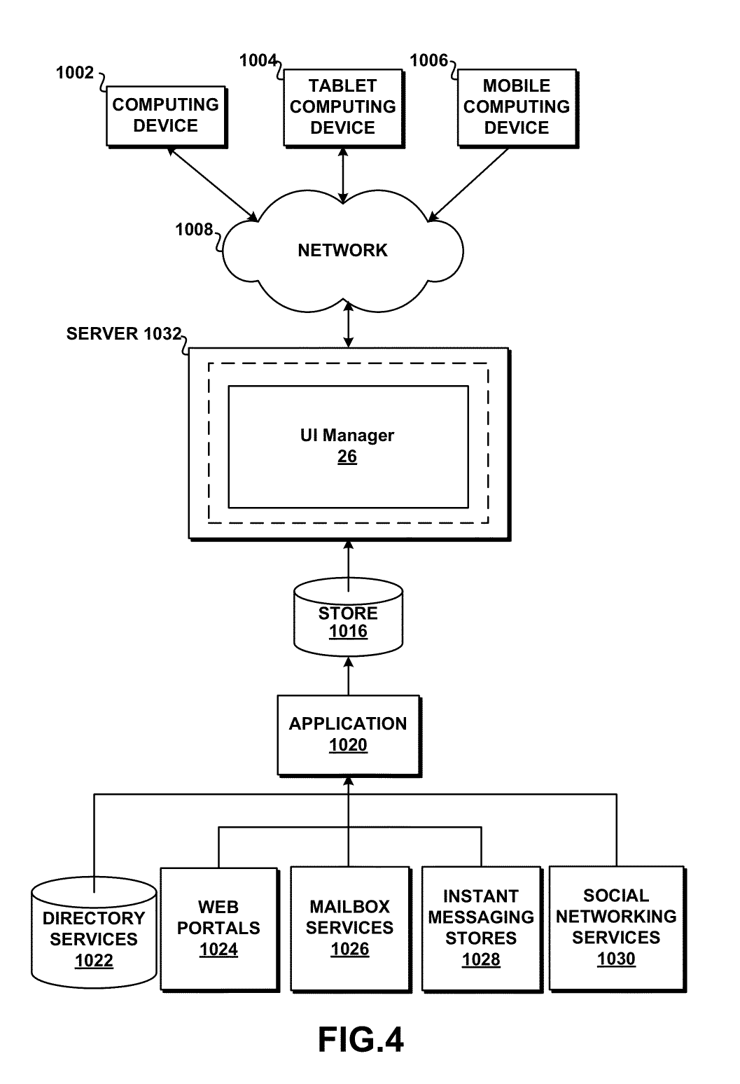

FIG. 4 illustrates a system architecture used in changing the display of user interface elements based on input, as described herein. Content used and displayed by the application (e.g. application 1020) and the UI manager 26 may be stored at different locations. For example, application 1020 may use/store data using directory services 1022, web portals 1024, mailbox services 1026, instant messaging stores 1028 and social networking sites 1030. The application 1020 may use any of these types of systems or the like. A server 1032 may be used to access sources and to prepare and display electronic items. For example, server 1032 may access UI elements for application 1020 to display at a client (e.g. a browser or some other window). As one example, server 1032 may be a web server configured to provide productivity services (e.g. word processing, spreadsheet, presentation . . . ) to one or more users. Server 1032 may use the web to interact with clients through a network 1008. Server 1032 may also comprise an application program. Examples of clients that may interact with server 1032 and a spreadsheet application include computing device 1002, which may include any general purpose personal computer, a tablet computing device 1004 and/or mobile computing device 1006 which may include smart phones. Any of these devices may obtain content from the store 1016.

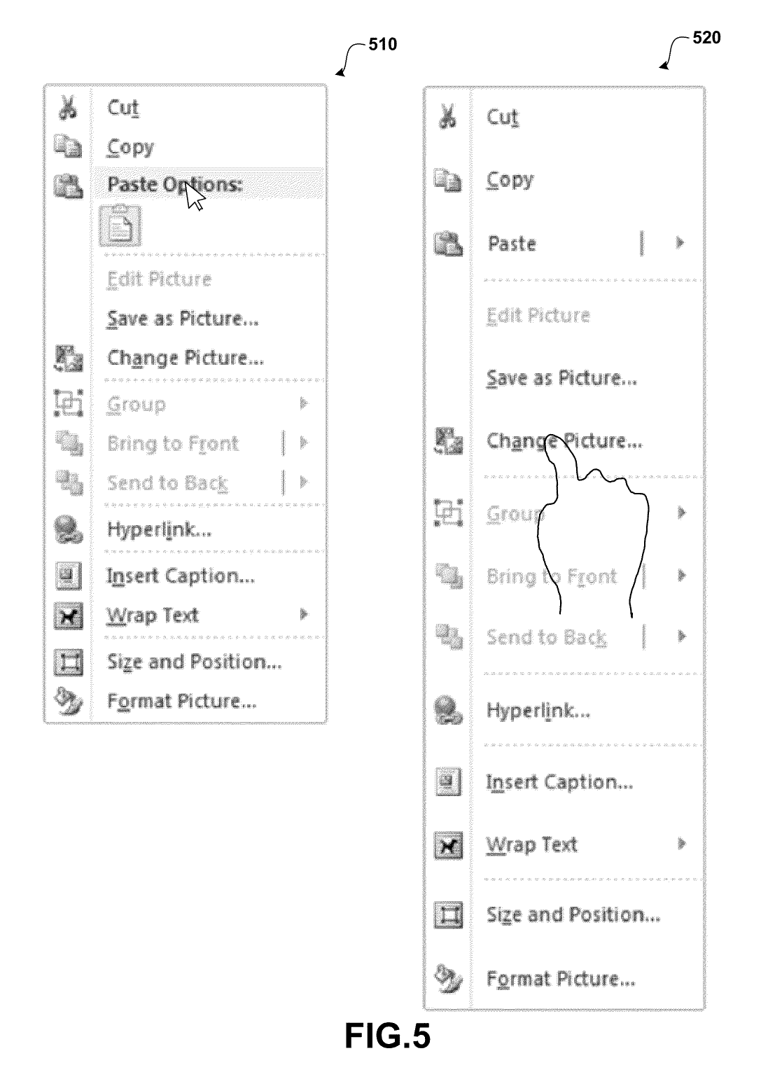

FIGS. 5-7 illustrate exemplary displays showing user interface elements configured for touch and hardware based input. FIGS. 5-7 are for exemplary purpose and are not intended to be limiting.

FIG. 5 shows UI elements arranged for hardware based input and UI elements arranged for touch input.

As illustrated, display 510 and display 520 each show a same group of menu options. Each display may include different UI elements. For example, window 520 may include more options than display 510. The displays may be associated with a desktop application, a mobile application and/or a web-based application (e.g. displayed by a browser). The display may be displayed on a limited display device (e.g. smart phone, tablet) or on a larger screen device.

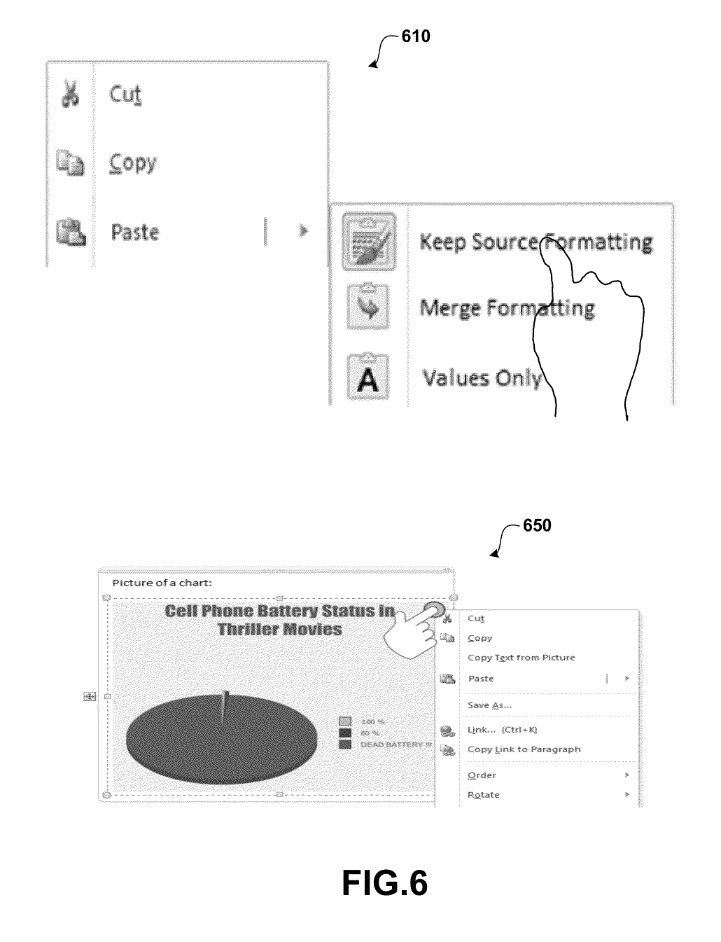

As illustrated, hardware based input display 510 shows the menu options displayed closer together as compared to touch input display 520. Changing the spacing of the UI element is directed at making it easier to select an option. Different menu options may also change based on whether or not input is touch input or hardware based input. For example, the Paste Option menu elements are displayed differently. In the hardware based input display 510, different paste options are displayed beneath the “Paste Options:” menu. In the touch input display 520, a fly out option is displayed such that it is easily selectable using touch input (See FIG. 6 for example fly out menu). UI elements that are associated with hardware based input may also be changed to work with touch based input. For example, many touch systems do not detect a hovering action. As such, UI elements that have an associated hover action are converted to work with touch input (e.g. tooltips are displayed next to a display of an element).

FIG. 6 shows UI elements arranged for touch input.

Display 610 shows menu items for a paste option that include a display of tooltips 620 in addition to the display of the icon. The size of the options are also displayed larger than the corresponding display of the hardware based input display.

Display 650 shows menu items that include a display of options relating to a picture.

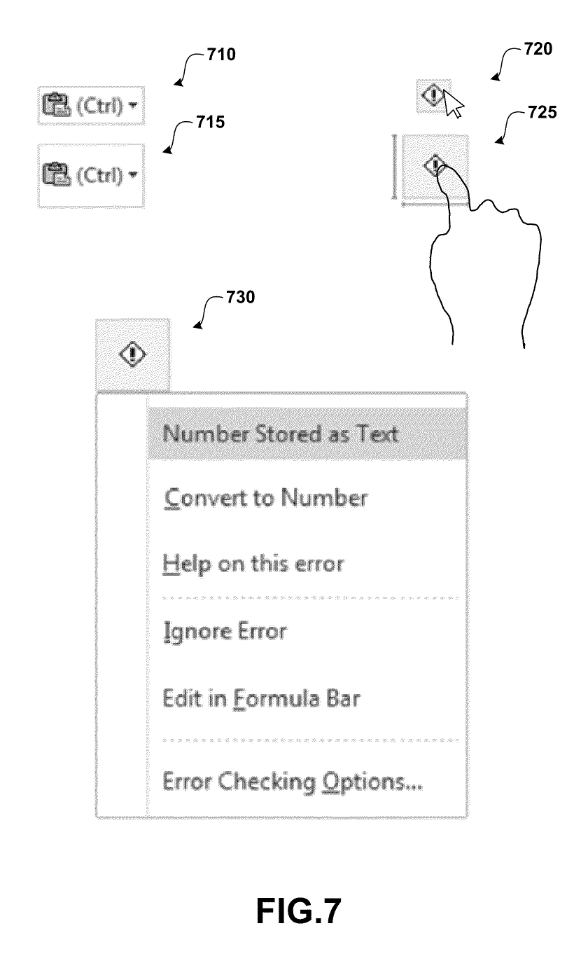

FIG. 7 shows UI elements sized for hardware based input and UI elements sized for touch input.

Hardware based input UI elements (e.g. 710, 720) are displayed smaller than corresponding touch input UI elements (e.g. 715, 725).

Display 730 shows selection of touch based UI element 725. The spacing of the menu option is display 730 are farther apart as compared to a corresponding hardware based input menu.

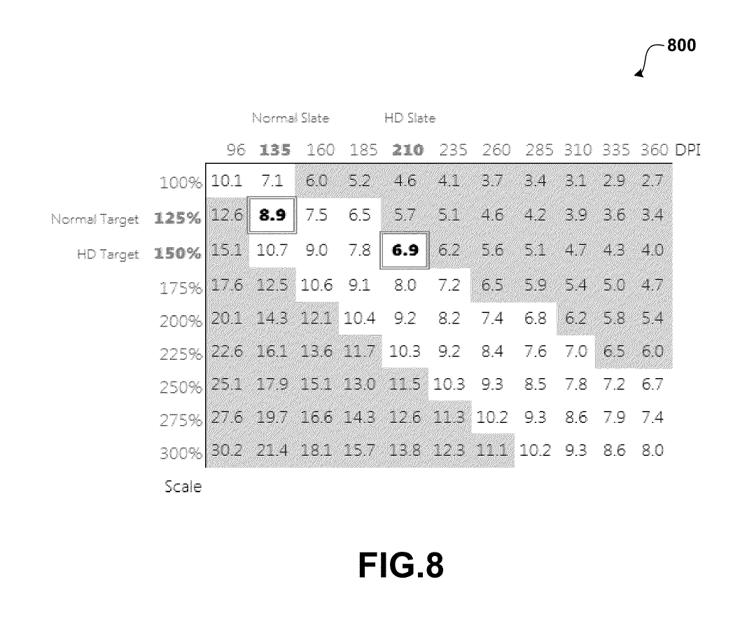

FIG. 8 illustrates an exemplary sizing table that may be used in determining a size of UI elements.

Table 800 shows exemplary selections for setting a size of UI elements that are configured for touch. According to an embodiment, a target size of 9 mm is selected with a minimum size of 6.5 mm. Other target sizes may be selected.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for displaying User Interface (UI) elements, comprising:
accessing an application that includes UI elements configured for use with touch input and UI elements configured for use with hardware based input;
receiving input to interact with the application;
determining when the input is touch input and when the input is hardware based input;
displaying the UI elements configured for use with the touch input when is determined that touch input is being used to interact with the application; and
displaying the UI elements configured for use with the hardware based input when is determined that hardware based input is being used to interact with the application.

2. The method of claim 1, further comprising automatically changing the display of the UI elements in response to detecting a change from using touch input to hardware based input and from using hardware based input to touch input.

3. The method of claim 1, wherein displaying the UI elements configured for use with the touch input when is determined that touch input is being used to interact with the application comprises changing a spacing of a display of each of the UI elements.

4. The method of claim 1, further comprising disabling hover input when it is determined that touch input is being used to interact with the application.

5. The method of claim 4, further comprising automatically displaying content from an associated tooltip with the display of a related UI element when receiving the touch input.

6. The method of claim 1, wherein displaying the UI elements comprises changing a size of a display of each of the UI elements in response to determining when the input is the touch input and when the input is the hardware based input.

7. The method of claim 1, wherein displaying the UI elements comprises changing a context menu that is associated with a right click menu to be selectable using touch when receiving the touch input.

8. The method of claim 1, wherein displaying the UI elements comprises adding a cut command, a copy command, a paste command and a delete command to a display of the UI elements when receiving the touch input.

9. The method of claim 1, wherein a size of the display of the user interface elements is between about 6.5 mm and 9 mm when receiving the touch input.

10. A computer-readable medium storing computer-executable instructions for displaying User Interface (UI) elements, comprising:
accessing functionality that includes UI elements configured for use with both touch input and UI elements configured for use with hardware based input;
receiving input to interact with the application;
determining when the input is touch input and when the input is hardware based input;
configuring the UI elements based on the determined type of input;
displaying the UI elements configured for use with the touch input when is determined that touch input is being used to interact with the application; and
displaying the UI elements configured for use with the hardware based input when is determined that hardware based input is being used to interact with the application.

11. The computer-readable medium of claim 10, further comprising automatically changing the display of the UI elements in response to detecting a change from either using touch input to hardware based input and from using hardware based input to touch input.

12. The computer-readable medium of claim 10, wherein configuring the UI elements based on the determined type of input comprises changing a spacing of a display of each of the UI elements.

13. The computer-readable medium of claim 10, further comprising disabling hover input when it is determined that touch input is being used to interact with the application.

14. The computer-readable medium of claim 13, further comprising automatically displaying content from an associated tooltip with the display of a related UI element when receiving the touch input.

15. The computer-readable medium of claim 10, wherein configuring the UI elements based on the determined type of input comprises changing a size of a display of each of the UI elements.

16. The computer-readable medium of claim 10, wherein configuring the UI elements based on the determined type of input comprises changing a layout of a menu.

17. A system for displaying User Interface (UI) elements, comprising:
a display that is configured to receive touch input;
a processor and memory;
an operating environment executing using the processor;
an application that includes; and
a UI manager operating in conjunction with the application that is configured to perform actions comprising:
accessing functionality that includes UI elements configured for use with both touch input and UI elements configured for use with hardware based input;
receiving input to interact with the application;
determining when the input is touch input and when the input is hardware based input;
configuring the UI elements based on the determined type of input;
displaying the UI elements configured for use with the touch input when is determined that touch input is being used to interact with the application;
displaying the UI elements configured for use with the hardware based input when is determined that hardware based input is being used to interact with the application; and
automatically changing the display of the UI elements in response to detecting a change from either using touch input to hardware based input and from using hardware based input to touch input.

18. The system of claim 17, wherein configuring the UI elements based on the determined type of input comprises changing a spacing of a display of each of the UI elements.

19. The system of claim 17, further comprising automatically displaying a description with at least a portion of the UI elements when receiving the touch input that are not displayed when receiving the hardware based input.

20. The system of claim 17, wherein configuring the UI elements based on the determined type of input comprises changing a size of a display of each of the UI elements.
